(19) United States
(12) Patent Application Publication
(10) Pub. No.: US 2014/0096691 A1
(43) Pub. Date: Apr. 10, 2014

(54) CONTAINER CRUSHER

(71) Applicant: David Martin, Saegertown, PA (US)

(72) Inventor: David Martin, Saegertown, PA (US)

(21) Appl. No.: 14/046,608

(22) Filed: Oct. 4, 2013

Related U.S. Application Data
(60) Provisional application No. 61/709,599, filed on Oct. 4, 2012.

(51) Int. Cl. B30B 9/32; B30B 9/30

(52) U.S. Cl. CPC B30B 9/321; B30B 9/3096
USPC 100/35; 100/266

(57) ABSTRACT

A crusher for containers such as aluminum cans and plastic bottles is disclosed. The container crusher includes a base and a movable plunger that travels on support rods mounted on the base. The base and plunger have recesses that retain the container when it is crushed. Springs bias the plunger into its open position, and may be used to limit the downward movement of the plunger to provide a clearance distance from the base.

### CROSS-REFERENCE TO RELATED APPLICATION

This application claims the benefit of U.S. Provisional Patent Application Serial No. 61/709,599 filed Oct. 4, 2012, which is incorporated herein by reference.

### FIELD OF THE INVENTION

This invention relates to container crushers, and more particularly relates to crushers for aluminum cans, plastic bottles, and the like.

### BACKGROUND INFORMATION

Aluminum cans are often crushed after their use in order to save space when the cans are discarded or recycled. Examples of can crushers are disclosed in U.S. Pat. Nos. 4,228,734; 4,345,519; 4,417,512; 4,606,266; 5,009,155; 5,033,375; 5,293,816; 7,360,484; and 7,444,931. Such can crushers tend to be mechanically complicated and are not designed to also crush different kinds of containers, such as plastic bottles.

### SUMMARY OF THE INVENTION

This invention is a container crusher for use in the recycling of cans and bottles. The container crusher includes a base and a plunger movable toward and away from the base along support rods. The base of the container crusher may include a recess structured and arranged to receive the bottom of a container, such as a metal can or a plastic bottle in order to prevent lateral movement of the container during the crushing operation. A recess may be provided on the underside of the plunger configured to receive the upper portion of a bottle or can. In addition, a central hole may be provided in the plunger in order to receive the upper mouth portion of a bottle to be crushed.

A contact pin such as a metal rod, blade, screw or bolt may be located on the underside of the plunger in order to facilitate the crushing of certain types of containers. The contact pin provides a point of contact on the upper rim of the container that creates a region of increased stress in the container to initiate the collapse of the container.

The container crusher may also include biasing springs axially aligned on the support rods in order to reset the movable plunger to the upward position. The biasing springs may be used to limit the downward movement of the plunger to a lowermost position that provides a clearance space between the base and the plunger, thereby avoiding potential injuries to fingers and hands of the operator.

An aspect of the present invention is to provide a container crusher comprising a base, at least one support rod connected to the base, and a plunger slidably mounted on the at least one support rod reciprocally movable with respect to the base, the plunger comprising a recess structured and arranged to receive an upper portion of a container to be crushed.

Another aspect of the present invention is to provide a plastic bottle crusher comprising a base, at least one support rod connected to the base, and a plunger slidingly mounted on the at least one support rod reciprocally movable with respect to the base, the plunger structured and arranged to receive an upper mouth of the plastic bottle to be crushed.

A further aspect of the present invention is to provide a method of crushing a container using a container crusher comprising a base, at least one support rod connected to the base, and a plunger slidably mounted on the at least one support rod reciprocally movable with respect to the base, the plunger comprising a recess structured and arranged to engage an upper portion of a container to be crushed. The method comprises placing a container to be crushed into the container crusher between the base and the plunger, and applying a downward force to the plunger to move the plunger toward the base to thereby crush the container.

These and other aspects of the present invention will be more apparent from the following description.

### BRIEF DESCRIPTION OF THE DRAWINGS

FIG. 1 is a side view of an embodiment of a container crusher with a can loaded therein, as well as an illustration of a crushed can.

FIG. 2 is a side view of an embodiment a container crusher with a plastic bottle loaded therein, as well as an illustration of a crushed bottle.

FIG. 3 is an isometric view of an embodiment of a container crusher.

FIG. 4 is a side sectional view of an embodiment of a container crusher with a can loaded therein and retained within recesses in the base and plunger of the crusher.

FIG. 5 is another side sectional view of an embodiment of a container crusher with a can retained therein, illustrating a contact pin extending downward from the plunger in contact with the can.

FIG. 6 is a side sectional view of a container crusher similar to that shown in FIG. 4 with a plastic bottle loaded therein, illustrating retention of the necked mouth portion of the bottle with a recessed hole of the plunger.

FIG. 7 is an isometric view of the underside of a plunger used in a container crusher in accordance with an embodiment of the invention.

FIG. 8 is a top view and FIG. 9 is a bottom view of the plunger shown in FIG. 7.

FIG. 10 is a side view of an embodiment of a container crusher with the plunger in its lowermost position, illustrating how biasing springs may be used to prevent the plunger from contacting the base to provide a clearance distance therebetween.

### DETAILED DESCRIPTION

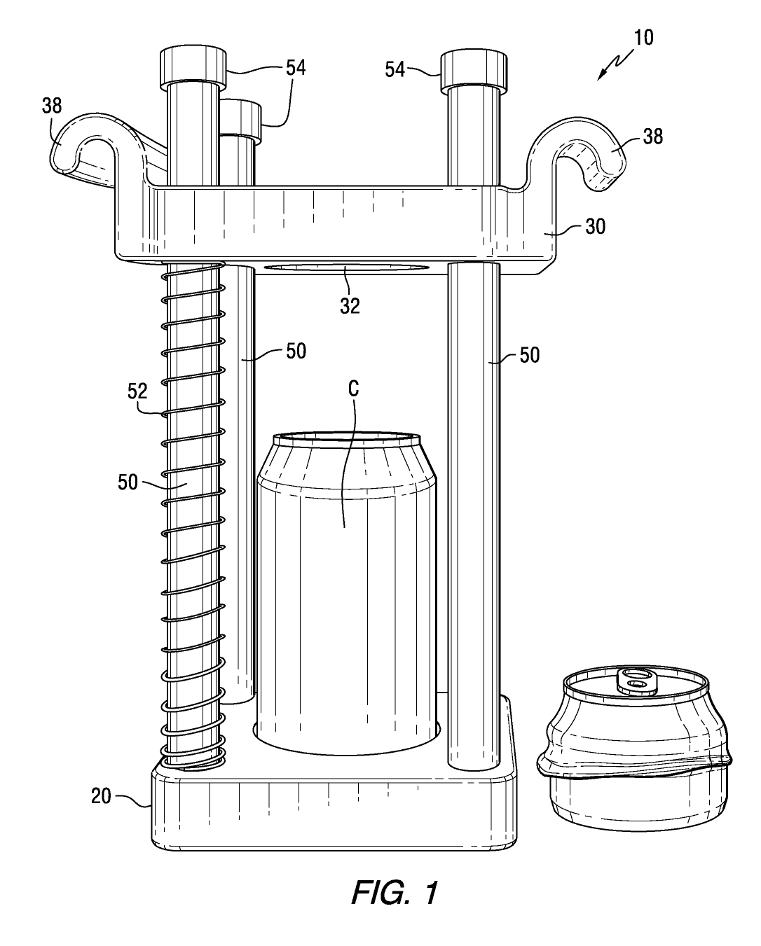

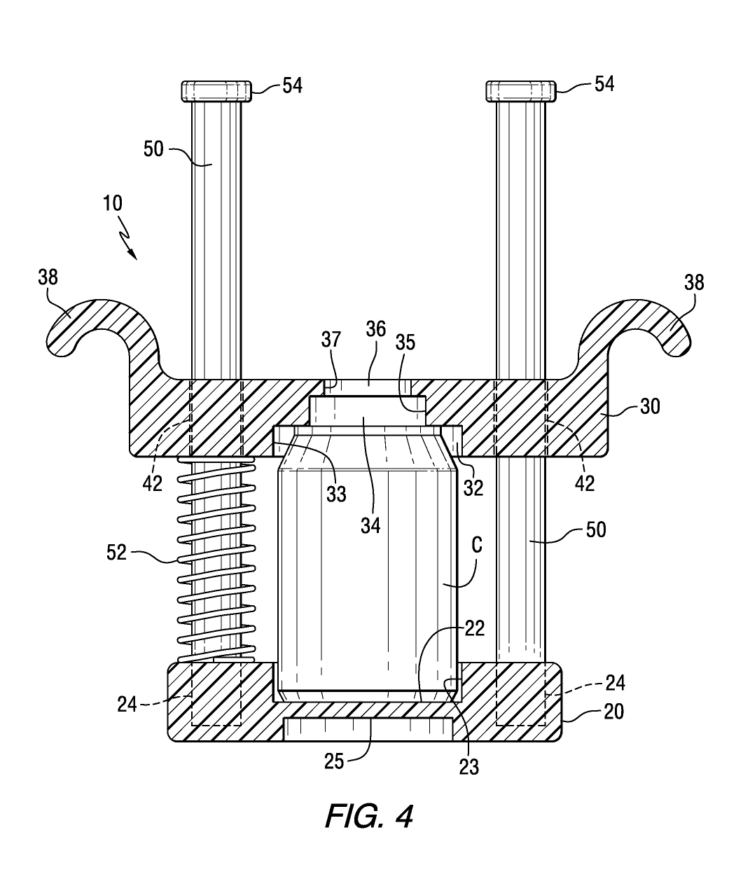

As illustrated in FIGS. 1-6, the present invention provides a container crusher 10 including a base 20 and a plunger 30 movable toward and away from the base 20 along support rods 50. The base 20 may include a recess 22 structured and arranged to receive the bottom of a container, such as a metal can C or a plastic bottle B. The recess 22 prevents lateral movement of the container during the crushing operation.

The plunger 30 may include central recesses 32, 34 and/or openings 36 structured and arranged to receive the top portions of various types of containers, such as the lid of an aluminum can C or the shoulder or neck portion of a plastic bottle B. Such recesses and/or openings in the plunger 30 may prevent lateral movement of the container during the crushing operation.

The plunger 30 may be moved toward and away from the base 20 by sliding engagement with the support rods 50. In certain embodiments, the plunger 30 may be biased away from the base 20 toward an open position by springs 52. The plunger 30 may be manually forced downward toward the base 20 against the force of the biasing springs 52 during a crushing operation, followed by movement of the plunger 30 away from the base 20 to the open position by the force of the springs 52. The plunger 30 may be provided with at least one handle 38 structured and arranged to be grasped by an operator during the crushing operation. For example, the plunger 30 may comprise two handles 38 on opposite edges thereof.

In certain embodiments, at least one contact pin 40 is provided on the underside of the plunger 30 to facilitate crushing of certain types of containers. For example, the contact pin 40 may comprise a rod, blade, cap screw, hardened bolt, or the like. The contact pin 40 is structured and arranged to contact a portion of a container, such as one point along the upper rim of a can lid, to provide a point of contact that creates a region of increased stress in the container to initiate the collapse of the container. The contact pin 40 thus helps to initiate the collapse of cans or other containers in order to reduce the force necessary to crush the container.

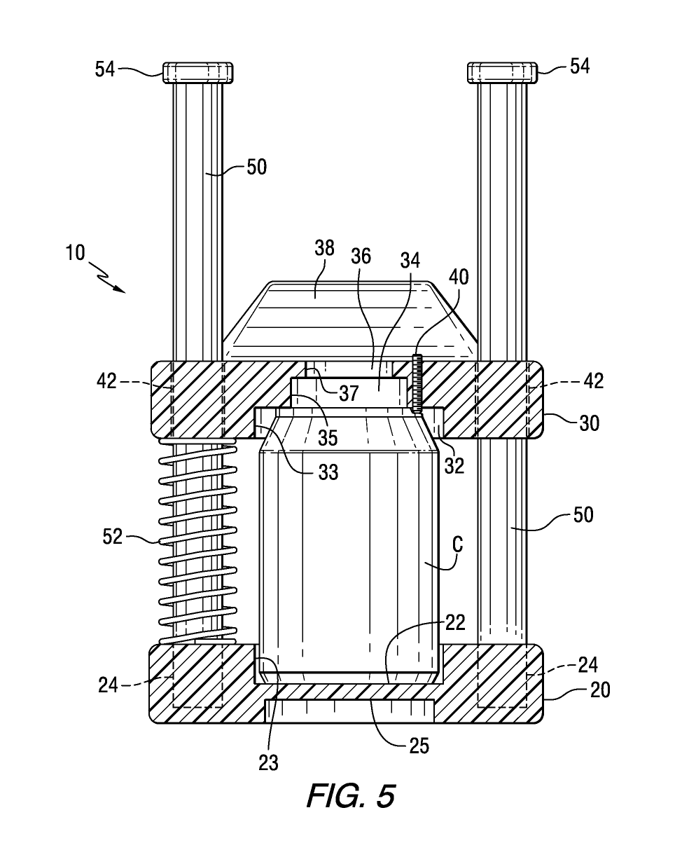

As shown in FIGS. 1, 4 and 5, the container crusher 10 may be loaded with an aluminum can C to be crushed. The can C is positioned in the recess 22 of the base 20 of the crusher 10. The recess 22 has a side wall 23 with a typical diameter of from 1 to 4 inches, for example, from 1.5 to 3.5 inches, or from 1.95 to 3.15 inches, or from 2.3 to 2.8 inches. When the plunger 30 is moved downward from the position shown in FIG. 1 to a position in which the plunger 30 initially contacts the can C, the first circular recess 32 in the underside of the plunger 30 surrounds the upper edge of the can C to prevent lateral movement of the can C when it is crushed. As shown in FIG. 5, when the plunger 30 is initially engaged with the aluminum can C, the contact pin 40 is engaged with one point on the rim of the can C to be crushed. The contact pin 40 generates a high stress point in the rim of the can C, which facilitates the collapse of can C in order to reduce the force necessary to crush the container.

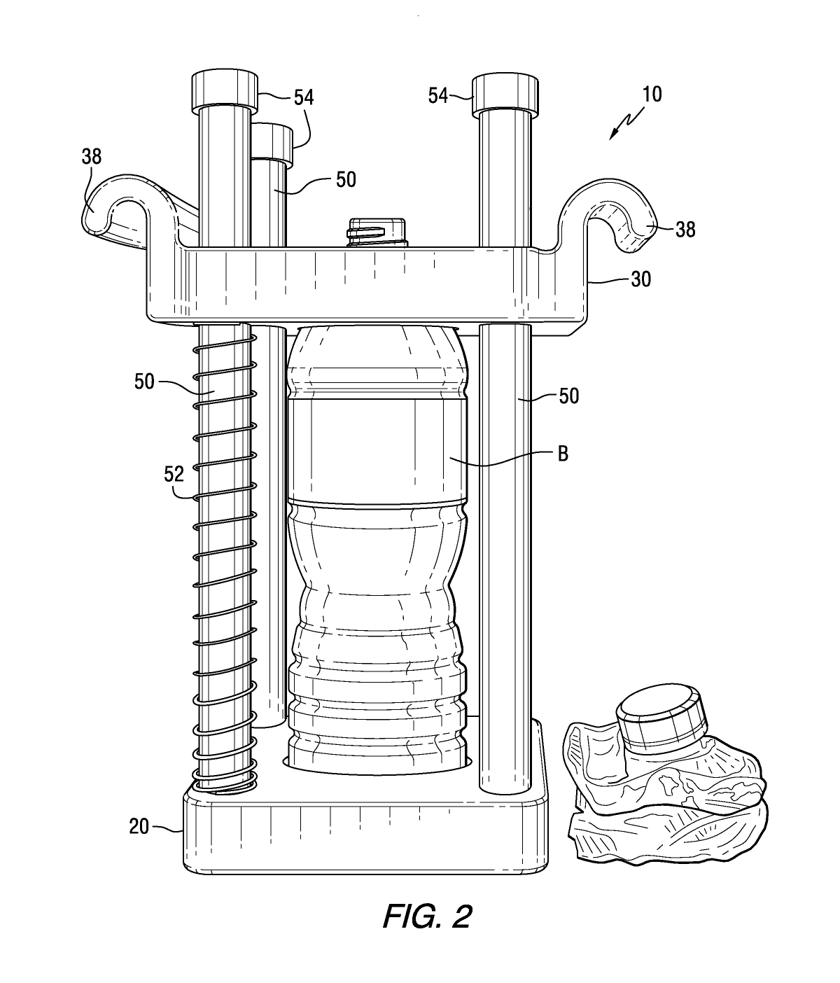

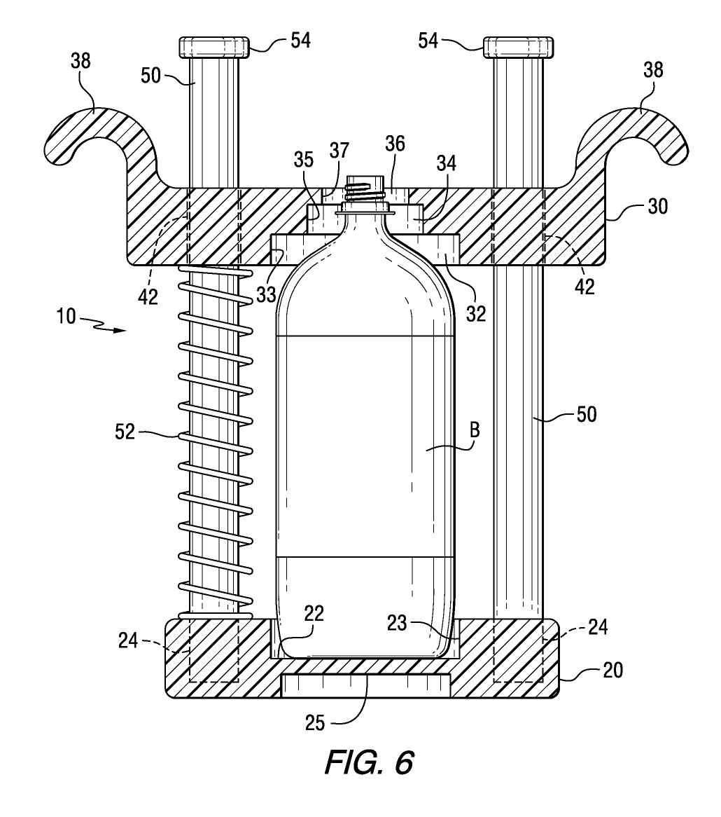

As shown in FIGS. 2 and 6, the container crusher 10 may be loaded with a plastic bottle B to be crushed. The base of the plastic bottle B is positioned in the recess 22 of the base 20, and the upper mouth and neck of the bottle are positioned within a central hole 36 in the plunger 30. The first and second recesses 32 and 34 in the plunger 30 may be structured and arranged to retain bottles of typical sizes and shapes. For example, the hole 36 may be sized to receive a standard water bottle mouth, and the recesses 32 and 34 may be sized to receive shoulder portions of various types of bottles. The arrangement of the central hole 36 and recesses 32 and 34 prevents lateral movement of the plastic bottle B during the crushing operation. In certain embodiments, the lid or cap of the bottle is removed during the crushing operation to allow the escape of air from the bottle B when it is collapsed. After the plastic bottle-crushing operation, the lid or cap of the crushed bottle may be secured on the opening of the bottle B in order to resist expansion of the bottle after it has been crushed.

The first recess 32 has side wall 33 with a typical diameter of from 1 to 4 inches, for example, from 1.5 to 3.5 inches, or from 1.95 to 3.15, or from 2.3 to 2.8 inches. The second recess 34 has a side wall 35 with a typical diameter of from 0.5 to 3 inches, for example, from 0.75 to 2.4 inches, or from 1.15 to 2 inches. The opening 36 may be generally cylindrical with a typical diameter of from 0.5 to 3 inches, for example, from 0.7 to 2.4 inches, or from 0.75 to 1.6 inches. In the embodiment shown in FIG. 6, the side wall 33 of wide recess 32 and the side wall 35 of narrow recess 34 are generally cylindrical in shape. Alternatively, the side walls 33 and 35 may have a frustoconical shape, concave shape, or the like.

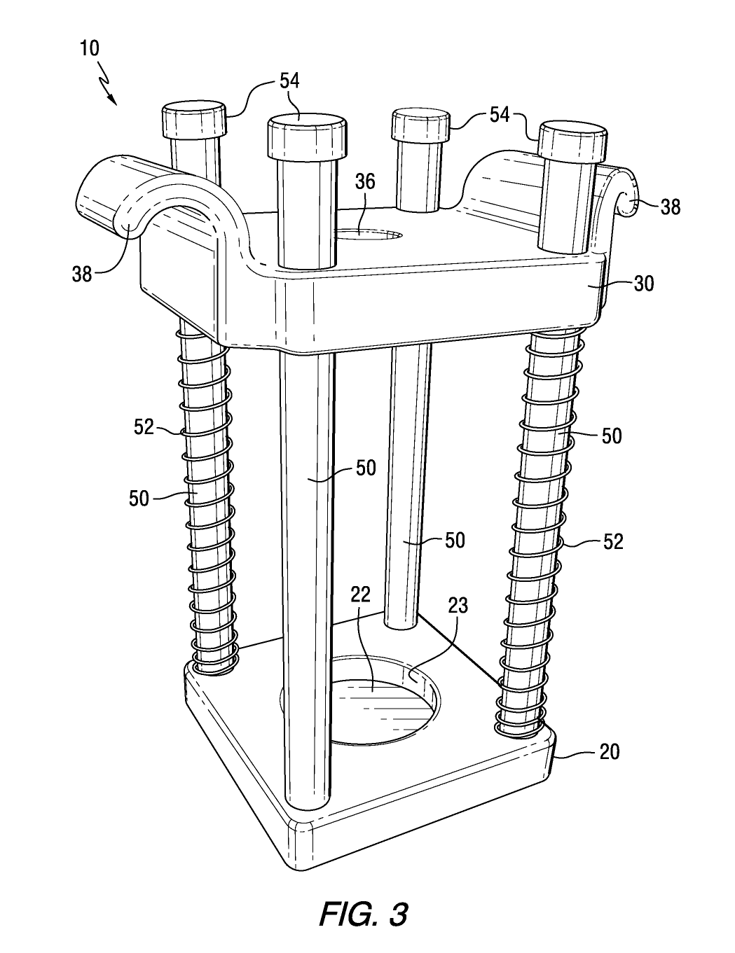

As shown in FIG. 3, end caps 54 are mounted on the support rods 50 retain the plunger 30 on the support rods 50. Springs 52 mounted on the support rods 50 bias the plunger 30 to its upper position between crushing operations, facilitating loading of a container to be crushed into the container crusher without intervention by the operator to hold the plunger 30 in the upper position.

In accordance with certain embodiments, sufficient tolerance is provided between the outer diameter of each support rod 50 and the inner diameter of upper receiving holes 42 extending through the plunger 30 such that the plunger 30 can freely move along the support rods 50 while preventing too much play in the angle of the plunger 30. For example, the tolerance may permit up to a ±10 degree or ±5 degree angle of variation between the orientation of the plunger 30 and the axial direction of the support rods 50. In one embodiment, the support rods 50 have outer diameters of 0.625 inch and the upper receiving holes 42 through the plunger 30 have inner diameters of 0.630 inch. Such an arrangement may result in binding of the plunger 30 if force is not provided evenly during the crushing operation. Thus, an operator may be required to use two hands on either side of the plunger 30 to create uniform force and prevent binding, thereby preventing one-handed operation that could potentially allow an operator to otherwise injure their hand or fingers if placed between the base 20 and plunger 30 during the crushing operation.

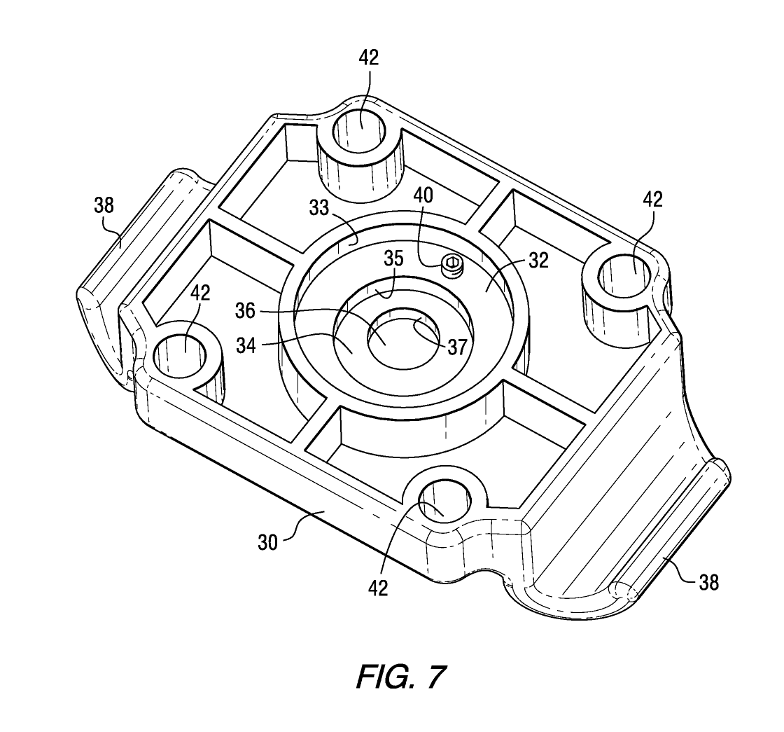

FIG. 7 illustrates details of the plunger 30, including handles 38 by which an operator may apply downward force during a crushing operation, upper receiving holes 42 which can accommodate the support rods 50, wide and narrow recesses 32, 34, with side walls 33, 35 the contact pin 40, and the central opening 36 with side wall 37.

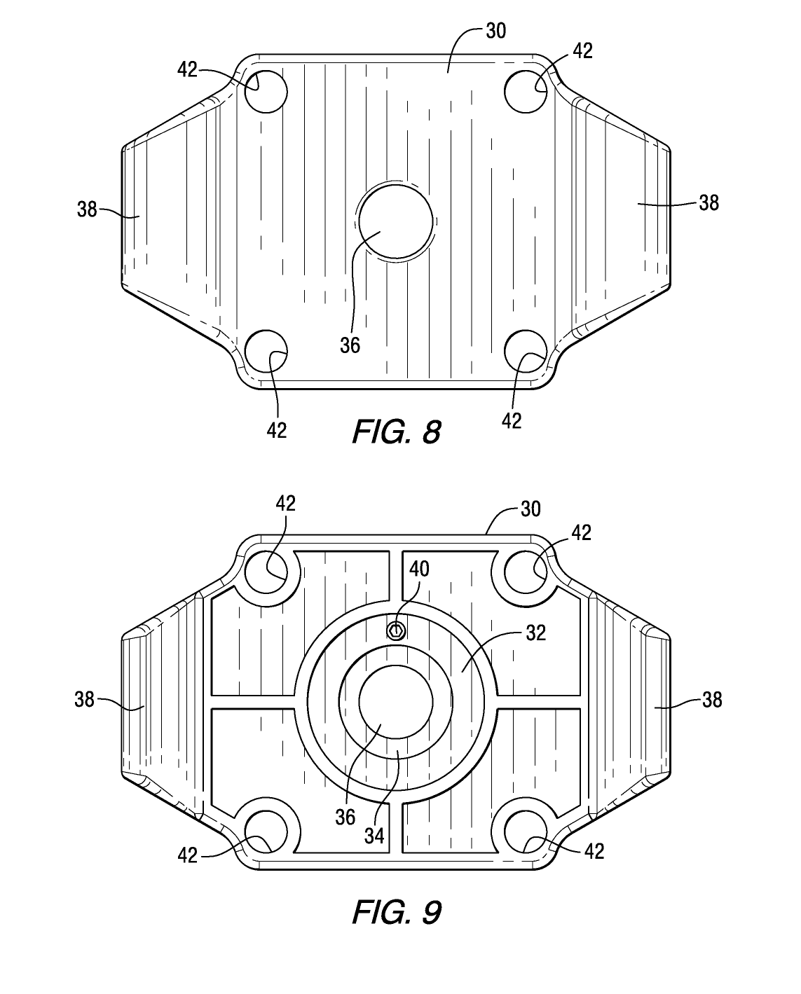

FIG. 8 is a top view of the plunger 30 of the container crusher 10, showing the upper receiving holes 42 for the support rods 50, as well as the handles 38 which are used to grip the plunger 30 to apply downward vertical force to crush a container.

FIG. 9 is a bottom view of the plunger 30 of the container crusher 10, showing the upper receiving holes 42 for the support rods 50, the first recess 32 for engaging a can or bottle, the second recess 34 for engaging a bottle, the central hole 36, and the contact pin 40 for applying initial force to a can in order to facilitate deformation during a crushing operation.

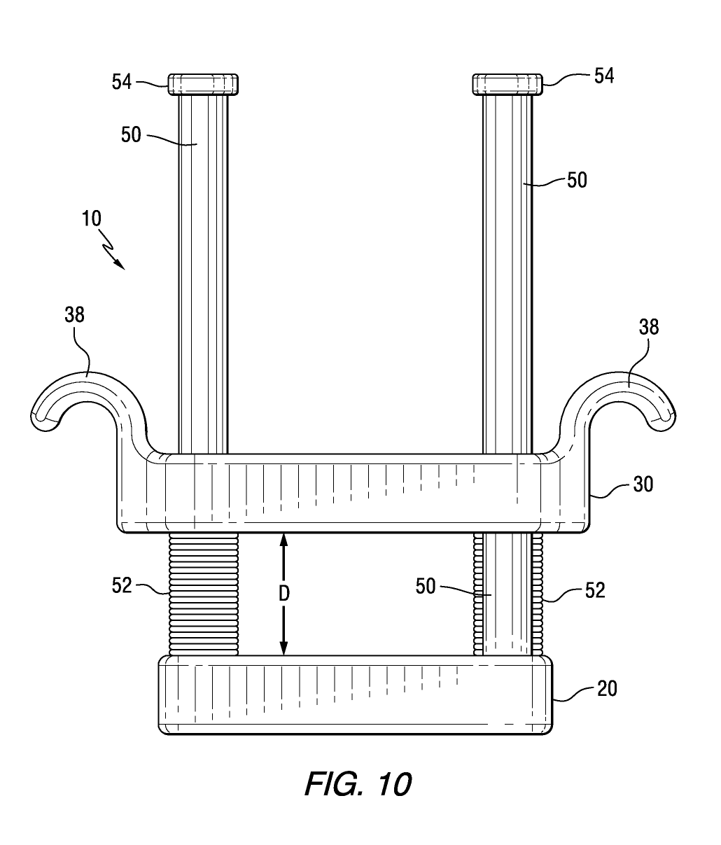

FIG. 10 is a side view of the container crusher 10 with the plunger 30 in its lowermost position. As shown in FIG. 10, the biasing springs 52 act as a mechanical stop in order to prevent the plunger 30 from contacting the base 20. A clearance distance D is provided between the upper surface of the base 20 and the lower surface of the plunger 30, which is sufficient to prevent the operator from injuring his or her hands or fingers during operation. The clearance distance D is sufficiently small to permit sufficient crushing of various containers. For example, the clearance distance D may be from 0.5 to 2 inches, or from 0.75 to 1.6 inches. This feature improves safety of the crusher 10 by preventing the hands or fingers of an operator from being pinched or otherwise injured during a crushing operation. While the use of two biasing axially aligned springs 52 is shown in the figures, it is to be understood that any other suitable number of springs may be used. Also, while four support rods 50 are shown in the figures, any other suitable number of rods may be used.

The components of the container crushers may be made from any suitable materials. For example, the base 20 and plunger 30 may be made of hard structural plastic such as polypropylene or the like. As a particular example, the base 20 and plunger 30 may be made of injection molded polypropylene with the addition of nylon in a polypropylene to nylon ratio of 50:1. The support rods 50 may be made of a high-density self-lubricating polymer such as ultrahigh molecular weight (UHMW) plastic or the like. As a particular example, the rods 50 may be made of extruded acrylic. The self-lubricating rods 50 are preferably wear resistant and abrasion resistant. The support rods 50 may be solid or hollow. In the embodiment shown in the figures, the support rods 50 are hollow and the end caps 54 include an extended cylindrical projection that fits within the hollow openings in the rods 50. The end caps 54 on the top of each support rod 50 may be made of plastic, for example, the same plastic as the base and plunger 30. The biasing springs 52 may be made of stainless steel or the like.

Whereas particular embodiments of this invention have been described above for purposes of illustration, it will be evident to those skilled in the art that numerous variations of the details of the present invention may be made without departing from the invention as defined in the appended claims.

What is claimed is:

1. A container crusher comprising:
a base;
at least one support rod connected to the base; and
a plunger slidably mounted on the at least one support rod reciprocally movable with respect to the base, the plunger comprising a recess structured and arranged to receive an upper portion of a container to be crushed.

2. The container crusher of claim 1, wherein the plunger has a lower face with a first central recess for engaging an upper portion of the container to be crushed.

3. The container crusher of claim 2, wherein the first central recess of the plunger has an inner diameter of from 1.5 to 3.5 inches.

4. The container crusher of claim 2, wherein the lower face of the plunger has a second central recess or hole concentrically inside the first central recess for engaging a portion of the container to be crushed.

5. The container crusher of claim 4, wherein the hole is structured and arranged to receive the necked mouth portion of a bottle to be crushed.

6. The container crusher of claim 5, wherein the hole has a diameter of from 0.5 to 2 inches.

7. The container crusher of claim 1, wherein the plunger comprises handles on opposing edges thereof.

8. The container crusher of claim 1, wherein the base has an upper face with a recess structured and arranged to receive a bottom portion of the container to be crushed.

9. The container crusher of claim 8, wherein the recess of the base is generally cylindrical and has an inner diameter of from 1.5 to 3.5 inches.

10. The container crusher of claim 1, further comprising a contact pin located on a lower surface of the plunger structured and arranged to contact and deform a portion of the container to be crushed.

11. The container crusher of claim 10, wherein the contact pin extends downwardly from the lower surface of the plunger and comprises a rod, blade, screw or bolt.

12. The container crusher of claim 1, comprising a plurality of the support rods connected to the base adjacent to an outer perimeter of the base.

13. The container crusher of claim 12, wherein the plunger comprises a plurality of receiving holes located adjacent to an outer perimeter of the plunger for receiving the plurality of support rods.

14. The container crusher of claim 13, wherein sufficient tolerance is provided between an outer diameter of each of the support rods and an inner diameter of each of the receiving holes in said plunger such that the plunger can freely move in a vertical direction parallel with axial directions of the support rods while limiting rotational movement of the plunger out of a horizontal plane.

15. The container crusher of claim 14, wherein the rotational movement of the plunger out of the horizontal plane is limited to an angle of 5 degrees or less.

16. The container crusher of claim 1, wherein the at least one support rod is made of a high-density self-lubricating polymer.

17. The container crusher of claim 1, further comprising a biasing spring axially aligned with the at least one support rod biasing the plunger upward away from the base.

18. The container crusher of claim 17, wherein the at least one biasing spring, when fully compressed during a crushing operation, maintains a clearance distance between the base and the plunger.

19. A plastic bottle crusher comprising:
a base;
at least one support rod mounted on the base; and
a plunger slidingly connected to the at least one support rod reciprocally movable with respect to the base, the plunger structured and arranged to receive an upper mouth of the plastic bottle to be crushed.

20. The plastic bottle crusher of claim 19, wherein the plunger comprises a central hole through which at least a portion of the upper mount of the bottle can extend.

21. A method of crushing a container using a container crusher comprising a base, at least one support rod connected to the base, and a plunger slidably mounted on the at least one support rod reciprocally movable with respect to the base, the plunger comprising a recess structured and arranged to receive an upper portion of a container to be crushed, the method comprising:
placing a container to be crushed into the container crusher between the base and the plunger; and
applying a downward force to the plunger to move the plunger toward the base to thereby crush the container.

22. The method of claim 21, wherein the container is an aluminum can.

23. The method of claim 21, wherein the container is a plastic bottle.

24. The method of claim 22, further comprising:
removing a cap from the plastic bottle before the downward force is applied; and
replacing the cap on the plastic bottle after the plastic bottle is crushed.
